(19) United States
(12) Patent Application Publication
(10) Pub. No.: US 2023/0359975 A1
(43) Pub. Date: Nov. 9, 2023

(54) AUTOMATED ESG MAPPING

(71) Applicant: Avetta, LLC, Orem, UT (US)

(72) Inventors: Taylor Allis, Orem, UT (US); Indy Chakrabarti, Orem, UT (US); Danny Shields, Orem, UT (US); Nathan Bangerter, Orem, UT (US); Jeffrey Chien, Orem, UT (US); Juan Delgado, Orem, UT (US); Daniel Patrick Jenkins, Orem, UT (US); John Daniel Walker, Orem, UT (US); Aric Liesenfelt, Orem, UT (US); Ryan Walsh, Orem, UT (US)

(21) Appl. No.: 17/930,484

(22) Filed: Sep. 8, 2022

Related U.S. Application Data
(60) Provisional application No. 63/364,177, filed on May 4, 2022.

(51) Int. Cl. G06Q 10/06; G06Q 30/00

(52) U.S. Cl. CPC G06Q 10/06393; G06Q 30/018

(57) ABSTRACT

One example method includes determining, based on criteria, a sustainability query for a supplier, where the criteria include standards identified by a client, types of suppliers specified by the client, and a maturity level of the supplier, prompting the supplier to respond to the sustainability query, receiving supplier responses to the sustainability query, creating a compliance score for the supplier based on the supplier responses to the sustainability query, and providing the compliance score to the client. Part, or all, of the method may be performed, for example, by an automated ESG mapping platform.

### RELATED APPLICATION

This application hereby claims priority to U.S. Provisional Patent Application, Ser. 63/364,177, entitled AUTOMATED ESG MAPPING, filed 4 May 2022, and incorporated herein in its entirety by this reference.

### FIELD OF THE INVENTION

Embodiments of the present invention generally relate to sustainability in a supply chain context. More particularly, at least some embodiments of the invention relate to systems, hardware, software, computer-readable media, and methods, for automatically mapping sustainability compliance requirements to supply chain vendors, based on a hiring client materiality and the supplier maturity level.

### BACKGROUND

The extent to which suppliers of goods and services conform to established compliance standards may be of great importance to clients of those suppliers. For example, many clients are interested to whether a supplier complies with ESG (Environmental, Social, and Governance) standards. A client decision to use, or not, a particular supplier may depend upon the ESG compliance of that supplier.

Many clients today look to available global standards to collect and measure the ESG compliance of their suppliers. However, these global standards typically serve as a one-size-fits-all approach that may not fit well with the specific situation of a given client and/or supplier. Moreover, this approach may not effectively account for differences between suppliers. For example, it would make little sense to apply a standard that requires collection of information about carbon emissions to a small supplier of technical support services.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture according to some embodiments.

FIG. 2 discloses further aspects of an example architecture, and process flow, according to some embodiments.

FIG. 3 discloses aspects of an example computing entity operable to perform any of the claimed methods, processes, and operations.

### DETAILED DESCRIPTION OF SOME EXAMPLE EMBODIMENTS

Embodiments of the present invention generally relate to sustainability in a supply chain context. More particularly, at least some embodiments of the invention relate to systems, hardware, software, computer-readable media, and methods for automatically mapping sustainability compliance requirements to supply chain vendors, based on a hiring client materiality and the supplier maturity level.

Typical approaches to ESG compliance involve using approaches such as carbon calculations for example as a basis for creating a scoring system to rank companies on sustainability. By way of contrast, example embodiments embrace, among other things, a system to determine which questions concerning sustainability are material to a given organization, and what level of compliance with ESG standards those organizations require. These questions, and compliance level requirements, may be determined based on a maturity level of the organization.

In general, example embodiments of the invention include methods to automatically map sustainability compliance requirements to supply chain vendors, based on the hiring client materiality and the supplier maturity level. Note that as used herein, a ‘client’ includes a consumer, or potential consumer, of goods and/or services that may be provided by a supplier. Embodiments may associate a series of questions about the environmental, social, and governance (ESG) policies of supplier, based on criteria such as, but not limited to:
1. Any external standard(s) that a given client might want their suppliers to comply with—such standards may include, for example, ISO (international standards organization), SASB (Sustainability Accounting Standards Board), GRI (global reporting initiative), TCFD (Task Force on Climate-related Financial Disclosures), UN-SDG (United Nations sustainability development goals), and numerous other sustainability (or ESG or CSR) standards;
2. What types of suppliers the hiring client requires to be compliant with one or more standards—these supplier types, which may be specified by the client, may include, for example, client ‘Top 20’ spend vendors, suppliers in certain foreign geographical regions, suppliers with government contracts, suppliers with CO2 footprints, and suppliers that provide a particular type of product or service; and
3. The maturity level of the supplier—that is, a small or ‘less mature’ supplier may have less onerous compliance requirements than a large or ‘more mature’ multinational.

Using these and/or other criteria, an example system according to some embodiments may examine previous criteria to determine which of various sustainability questions and answer levels in the system may apply for a given supplier. The system may operate on an FaaS (Function as a Service) basis for one or more clients. In this approach, a client may subscribe to the FaaS, which may offer different subscription levels and corresponding features. In this way, the client is spared the burden of determining compliance and may simply obtain needed compliance information as part of its subscription to the FaaS.

In any case, a prospective supplier may then be asked by the system to answer those questions, and the system may score the responses of the supplier. The resulting scores may then be evaluated against one or more standards, such as external standards, to generate a compliance, or ESG Index, score. The ESG Index scores, which may be referred to herein simply as ‘scores,’ of one or more prospective suppliers, in one or more particular compliance areas, may then be trended over time so that a prospective client can view the compliance performance of the suppliers in those areas of interest to the client. In some embodiments, the system may operate to verify compliance documents and other information provided by prospective suppliers, and to notify prospective clients as to whether or not the prospective suppliers have provided adequate documentation. Whether or not this particular feature, and/or other features disclosed herein, is provided to a given client may be determined based on the service level to which that client has subscribed. Finally, in some embodiments, a client may insert its own questions for the system to pose to suppliers. The supplier responses may or may not be scored, as described earlier. If there is widespread client interest in the answer to a particular question, the system may be updated to include that question.

Note that an ESG Index score that is generated for a supplier may be a global standard score that may be the same for that supplier regardless of the various client connections that the supplier may have. This score may be based in whole or in part on the conditional statements that reflect available questions and responses to a supplier regarding their company dynamics, maturity with regards to ESG, as well as prior responses that the supplier may have provided. The ESG Index value may thus provide a weighted average that is accurate with respect, only, to the questions that apply to a given supplier. Thus, the use of respective ESG Index scores for multiple different suppliers provides a way to ‘level the playing field’ for a global range of suppliers, and those ESG Index scores may each scale to accommodate new standards introduced in the global ESG space. Because the ESG Index score may take the form of a global score that is unique to a particular supplier, the ESG Index scores may enable the baselining of a supplier against other suppliers in the same client network, industry, or the entire global network of suppliers, so that multiple suppliers can be compared to each other using a common reference, that is, their respective ESG Index scores.

Thus, example embodiments may operate to, among other things, replicate an automated ESG maturity mapping system across multiple global compliance standards. Given the landscape of ESG and available methodologies is constantly shifting and consolidating as well, embodiments may be agnostic as to any specific methodology, and may implement and maintain a generalized alignment to the largest and most popular global methodologies. As well, the alignment to multiple global standards may be implemented as a baseline scoring system by example embodiments of the invention. This may include the factors and attributes disclosed herein, as well as in the workflow according to some embodiments that may assign a unique scale and weight to the ESG index, or score, associated with a particular company. As used herein, ESG includes, but is not limited to, all references to sustainability practices in the environmental, social and governance spaces.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that embodiments of the system may enable a client to readily determine the extent of ESG compliance of a prospective supplier, and then determine whether or not that compliance is consistent with established client requirements. An embodiment may enable a client to make sourcing decisions that are consistent with the philosophy and requirements of the client. Embodiments may enable clients to make sourcing decisions without requiring the clients to perform investigations and research into the compliance, or not, of prospective suppliers. The ability of one or more embodiments to source, that is, identify a supplier, at a higher level may also minimize the potential cost impact to a supplier prospect that may not meet initial requirements and expectations of a hiring/connecting client with regards to ESG compliance. Various other advantageous aspects of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview—Sustainability and ESG

In general, example embodiments may operate to assess the level of Sustainability and ESG (Environmental, Social, Governance) compliance that a supplier has, and to provide that information to the client. The supplier compliance may viewed through the lens of the client requirements and the external compliance standards used by the client. For example, a large food retailer may be required to certify that its meat suppliers do not have added hormones in their animals and production processes.

Embodiments may operate to support a robust experience for ESG where by collecting data from various companies of varying sizes, locations, and backgrounds, and also by providing a path to growth while recognizing that companies start at different points in regard to their respective ESG maturity levels. Note that as used herein, ‘ESG maturity’ may refer to the level of compliance, with one or more applicable sustainability standards, that a supplier needs as determined based on one or more characteristics of that supplier. Example supplier characteristics may include company size, industry, and region where the company operates, and/or provides its goods and services. Thus, example embodiments include a computer-implemented system that may be configured to collect information and use that information to establish the unique maturity level of suppliers, while also considering historical inputs from the supplier, as the maturity of a supplier may be expected to continue to progress in ESG. These inputs may enable the scoring platform to establish unique thresholds for ESG maturity, so as to provide a level playing field that permits the comparing of different suppliers with each other, while still representing a standardized ESG Index score. This approach may, in turn, provide further data analytics across the network for filtering based on all supplier values, to track the ESG progress, or regression, or lack of ESG progress, of one or more suppliers as a client monitors its supplier chain.

In more detail, with client ESG requirements and an evolving list of global standards, and companies of various sizes and regions being measured, the relative maturity of a company may serve as a key distinction for use in comparing that company against other companies. For example, a company with thousands of employees that provides critical transportation services in North America might be expected to have a higher maturity to ESG than a company in Asia with less than 50 employees that is providing technical support services as an outsource partner. The questions and the weight given with regards to the respective ESG index for each company, as well as the level of maturity expected between these two companies, may have to be reflected differently. The maturity expectations for a company may change over time, for example, from those starting at an ‘emerging’ maturity, progressing next to ‘established’ and then a ‘leading’ maturity level. If a company downsizes or divests a group or division, the maturity level may regress to a previous level.

### B. Aspects of an Example Architecture

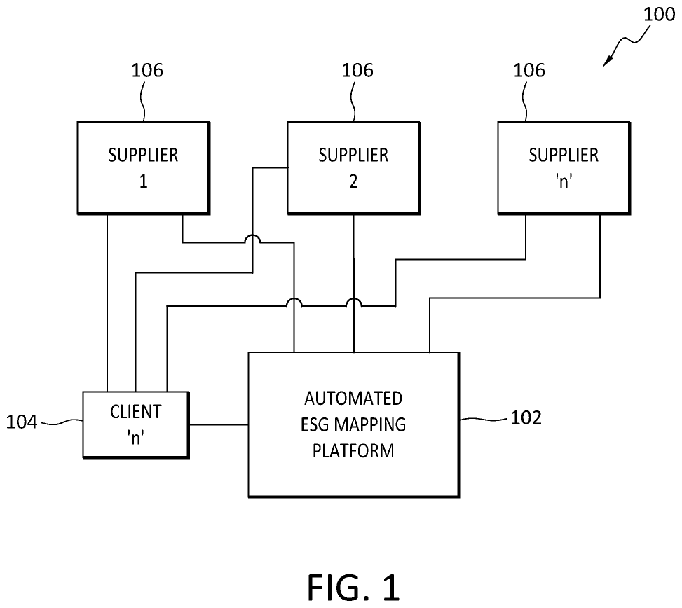

With attention now to FIG. 1, details are provided concerning an example architecture 100 according to some embodiments. The example in FIG. 1 is provided only by way of example, and is not intended to limit the scope of the invention in any way.

The example architecture 100 may include an automated ESG mapping platform 102, which may be referred to herein simply as a ‘mapping platform.’ The mapping platform 102 may perform any or all of the functions disclosed herein. In some embodiments, the mapping platform 102 may be hosted in a cloud computing environment, but that is not necessarily required, and the mapping platform 102 may be implemented in any other way that enables the functionality disclosed herein. Further, any one or more of the functions performed by the mapping platform 102 may be provided, possibly by way of an FaaS approach, to one or more clients 104. The example architecture 100 may include any number ‘n’ of clients 104. A client 14 may subscribe to any of a variety of different service levels provided by the mapping platform 102, based on the particular needs of the client 104.

The functions performed by the mapping platform 102 may be based in whole or in part on information concerning one or more suppliers 106 of goods and/or services. As noted herein, the mapping platform 102 may pose various questions and other inquiries to the suppliers 106, and the mapping platform 102 may perform various operations, such as trending and ranking of supplier compliance for example, based on the received input, that is, the supplier 106 responses to such questions and inquiries. Additionally, or alternatively, the mapping platform 102 may, on its own initiative, acquire information from third party sources, such as industry regulators and news sources for example, concerning ESG compliance related matters pertaining to one or more of the suppliers 106.

Based on the received input, the mapping platform 102 may generate various outputs, one example of which is a supplier compliance assessment that may be provided to a supplier 106. This supplier compliance assessment may indicate to the supplier 106 where it is, and is not, in compliance with various standards that may be of interest to one or more clients 104. Based on this assessment, the supplier 106 may take action to improve its compliance, which may then be reassessed at some future time by the mapping platform 102.

Another example output that may be generated by the mapping platform 102 is a list of suppliers 106, customized for a particular client 104, that lists relevant suppliers 106 ranked by their respective scores. Such a list may also indicate specifically where, and to what extent, a supplier 106 is compliant, or not, with respect to various standards specified by the client 104. Since some standards may be relatively more important to a client 104 than other standards, such information may help the client 104 make an informed decision about entering a business relationship with a particular supplier 106.

A client 104 may, on its own, directly query a supplier 106 for compliance information concerning that supplier 106. In some instances, that information may be provided by the client 103 to the mapping platform 102.

### C. Further Aspects of Some Example Embodiments

As noted earlier, and exemplified in FIG. 1, the operating environment for automated ESG mapping functionality according to some embodiments may be a cloud-based platform where suppliers connect with clients, and where suppliers can complete ESG related requirements. A supplier can be connected to one or many clients as part of a larger network. These responses by the supplier to questions posed by the mapping platform may be scored by the mapping platform based on the received maturity level of the supplier, providing detailed insights to clients as to where that supplier stands with respect to their ESG requirements, and with respect to various global standards. Clients may use this data to benchmark a supplier against other suppliers in their network, as well as to benchmark suppliers that they would actively search for and procure that they are not currently connected to.

The path of ESG maturity that a company may experience in the mapping platform, that is, the path to assignment of an ESG maturity level to the company, may comprise three parts. For example, the initial maturity classification assigned to a supplier may be based on the responses of that supplier to various questions, requests, and queries posed by the mapping platform. Such responses by a supplier might include, by way of illustration, responses such as the relevance of greenhouse gas (GHG) emission reporting, types of work, and contracts, a company engages in, or the materiality a company has with its connected clients in the large supplier chain. Next, a standardized set of attributes may be used by the mapping platform to further qualify a supplier and its maturity, wherein such attributes may include, for example, company size, geographic location of the company, and industries that may impact the business of the company. The final part of the generation and assignment, by the mapping platform, of a maturity level to a supplier is the alignment of supplier inputs to global ESG methodologies such as GRI (Global Reporting Initiative), VRF (Value Reporting Foundation) and SDG (Sustainable Development Goals) in the evolving ESG space. This provides flexibility to the connected clients who may have a preferred preference to one ESG methodology over another.

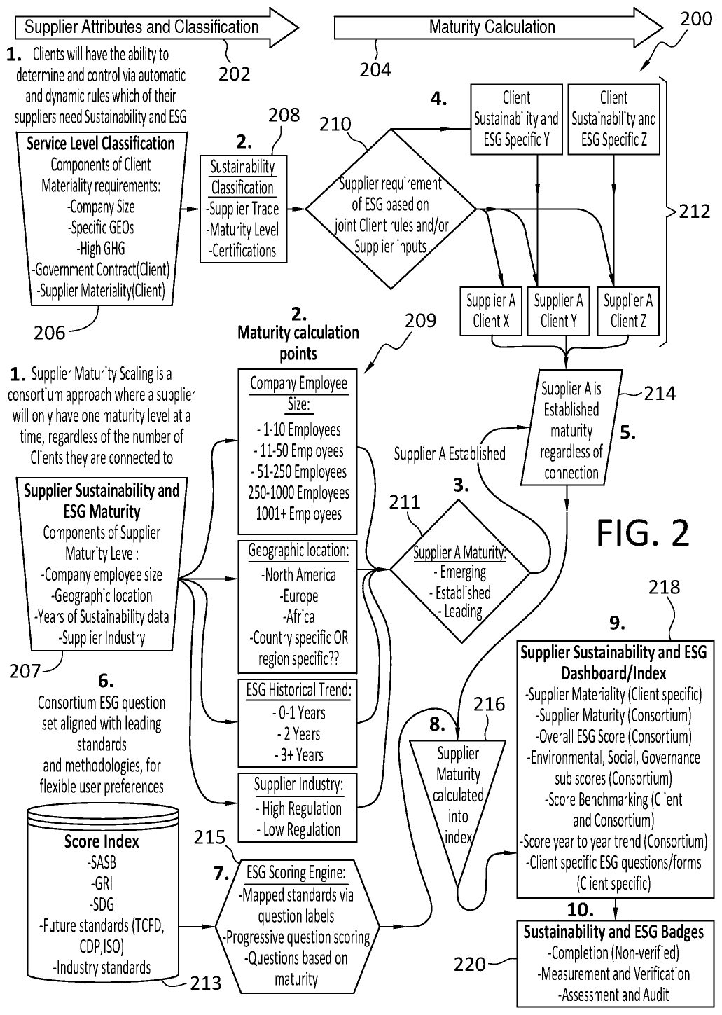

With reference now to FIG. 2, details are provided concerning an example flow and methodology, denoted at 200, according to some embodiments of the invention. It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Some, or all, of the method 200 may be implemented by, and/or at the direction of an automated ESG mapping platform (see reference 102 in FIG. 1), but that is not necessarily required. Client, and supplier, inputs referred to hereafter may be generated and/or supplied, for example, by suppliers (see reference 106 in FIG. 1) and by one or more clients (see reference 104 in FIG. 1).

In general, the method 200, which may be implemented in, and/or comprise, an architecture, such as the example architecture 100, may comprise two primary stages, namely, a supplier attributes and classification stage 202, and a maturity calculation stage 204 that may follow the supplier attributes and classification stage 202.

With reference to the supplier attributes and classification stage 202, a client may have the ability to determine, and control via automatic and dynamic rules, which suppliers of the client are required to meet client/other sustainability and ESG requirements, and to what extent the suppliers are required to meet those requirements. In this regard, and as noted earlier, a client may subscribe to various service levels provided by a supplier. Thus, a service level provided by a supplier may be classified at 206 by the client according to various client materiality requirements, which may include components such as company (i.e., supplier) size, and specific GEOs (global emission offsets), and low/medium/high GHG (greenhouse gas) emissions, associated with the supplier, whether the supplier has government contracts or not, and the materiality, or relatedness, of the supplier to the client. Materiality or relatedness may be a measure as to the relative amount of importance of the supplier and its goods/services to the client.

An output of the service level classification at 206 may be a sustainability classification 208 that may be applied by the customer to the service and/or the supplier. The sustainability classification may include, as its elements, the supplier trade or particular business of the supplier, a maturity level of the supplier (see 208 below), and any relevant certifications applied by the customer and/or certifying bodies.

In connection with 206, a supplier may be assigned a maturity level. In some embodiments, the maturity level may be determined, and assigned, using a consortium approach where a supplier has only a single assigned maturity level at any given time, regardless of the number of clients that particular supplier is connected with. This approach may be referred to as supplier maturity scaling. As shown at 207, supplier sustainability and ESG maturity may be based on various components, such as, for example, company size in number of employees, geographic location of the company, years of sustainability data available about the company, and the industry that the company is in.

One feature of the automation of the disclosed methods using a software platform is that at least some embodiments of those methods may be implemented using the consortium approach. This means that as a supplier is pre-classified in the system, the details provided by the supplier, as well as the client connections made by the supplier, may determine a dynamic set of standards to be met, by the supplier, for one set, or multiple sets, of client requirements. This may provide an automated and scalable model for suppliers to receive ESG requirements that best apply to the supplier, that is, requirements that are based on the supplier as a company, as well as the clients that the suppliers do business with. Also, the code architecture for the ESG Index may be such that the ESG Index value may be generated in real-time as changes occur to the inputs upon which that ESG Index value is based.

As shown at 209, various criteria may be used as maturity calculation points, that is, points or information which may be considered in the performance of a maturity calculation for a supplier. Example maturity calculation points may include, but are not limited to, company size (measured by the number of employees), geographic location of the company, an ESG historical trend of the company, and the level of regulation in the industry of the supplier. These maturity calculation points may be assessed/reassessed on an ongoing basis, and/or on an ad hoc basis.

At 211, after a supplier maturity has been determined 209 using various maturity calculation points, the supplier may be categorized. No particular categorization scheme is required. However, in some embodiments, a supplier maturity may be categorized as one of ‘emerging,’ ‘established,’ or ‘leading.’

With continued reference to FIG. 2, after a sustainability classification 208 has been applied by the customer to the service and/or the supplier, the supplier ESG requirement may be determined 210, based on client rules and/or supplier inputs concerning information about, for example, the operations of the supplier. That is, the ESG requirements imposed on the supplier by the client may be determined based on the sustainability classification that the client has assigned to that supplier. As shown at 212, client-specific sustainability and ESG requirements may, or may not, be assigned to one or more suppliers by one or more clients. For example, in the example of FIG. 2, client-specific requirements are applied to supplier A by client Y and client Z, but no requirements are applied to supplier A by client X.

Based on the assignment of various client-specific requirements to supplier A, supplier A may be assigned 214 one of the maturity levels determined at 211. Thus, in the example case of FIG. 2, supplier A is assigned a maturity level of ‘established.’ That is, the consortium of clients Y and Z has collectively identified supplier A is ‘established.’ As noted above, client X has not played a role in the determination of the maturity level of supplier A because client X has not assigned any client-specific requirements to supplier A.

The supplier maturity level that was determined 214 may be an input 216 to a process 218 for calculating a supplier sustainability and ESG index, such as may be displayed to a user on a supplier sustainability and ESG dashboard. Various other inputs may be employed in the generation of the supplier sustainability and ESG index. For example, a consortium ESG question set may be generated that is aligned with applicable standards and methodologies, so as to enable flexible user preferences in terms of the criteria that a client, or user, may apply to a supplier, and/or may use in assessing a supplier. More particularly, the questions in the question set may be configured to determine supplier compliance with standards 213 such as, but not limited to, SASB, GRI, SDG, industry standards, as well as future standards that may apply including, for example, TCFD, CDP, and ISO.

An ESG scoring engine 215 may map the various identified standards 213 to questions based on question labels, which may be assigned by a client and/or by the ESG scoring engine 215. As well, the ESG scoring engine 215 may implement progressive question scoring in which, for example, the ESG score is adjusted, if necessary, after the supplier provides a response to each successive question in the question set. In some cases, one or more questions for a supplier may be generated with reference to a known maturity level of that supplier. The output of the ESG engine 315 may be a supplier-specific ESG score, or index, that may serve as, or be combined with, the input 216 to the process 218 for calculating a supplier sustainability and ESG index.

More particularly, the process 218 may, using the input 216, assess, and/or generate, various measures relating to a particular supplier and/or a particular client or customer, and the process 218 may use such measures for calculating a supplier sustainability and ESG index. Such measures may include, but are not limited to, supplier materiality (client-specific measure), supplier maturity (may be assigned by consortium approach), overall ESG score (may be determined based on consortium approach), ESG sub-scores (may be assigned by consortium approach), ESG score benchmarks (determined by ESG benchmarking process—performed on client and/or consortium basis), year-to-year trends in ESG score (based on consortium approach), and client-specific ESG questions/forms.

Based on the aforementioned assessments, measures, and supplier sustainability and ESG index, various sustainability and ESG badges may be generated 220. In some embodiments, these badges may be generated by the process 218, but that is not necessarily required. Such badges may indicate, for example, that a supplier has completed an (un-verified) ESG assessment, that a supplier has participated in an ESG measurement and verification process, and/or that a supplier has participated in an ESG assessment and/or audit. Badges may be displayed, for example, on a supplier website, supplier invoices, and other locations/materials associated with the supplier. In general, a badge may provide a level of assurance to customers, and prospective customers, that the supplier is ESG aware, and that the supplier has made, and/or is making, ESG compliance efforts.

### D. Further Example Embodiments

Following are some further example embodiments of the invention. These are presented only by way of example and are not intended to limit the scope of the invention in any way.

Embodiment 1. A method, comprising: performing, by an automated ESG mapping platform, operations comprising: determining, based on criteria, a sustainability query for a supplier, wherein the criteria include standards identified by a client, types of suppliers specified by the client, and a maturity level of the supplier; prompting the supplier to respond to the sustainability query; receiving supplier responses to the sustainability query; creating a compliance score for the supplier based on the supplier responses to the sustainability query; and providing the compliance score to the client.

Embodiment 2. The method as recited in embodiment 1, further comprising publishing the compliance score.

Embodiment 3. The method as recited in any of embodiments 1-2, wherein the maturity level is a function of any one or more of: a number of employees of the supplier; a geographic location of the supplier; an ESG historical trend of the supplier; or, a level of regulation in an industry of the supplier.

Embodiment 4. The method as recited in any of embodiments 1-3, wherein the maturity level is determined using a consortium approach that involves one or more clients in addition to the client.

Embodiment 5. The method as recited in any of embodiments 1-4, wherein the supplier compliance score comprises an ESG index that is specific to the client.

Embodiment 6. The method as recited in any of embodiments 1-5, wherein the supplier has only a single maturity level at any given time, regardless of how many clients the supplier has at that given time.

Embodiment 7. The method as recited in any of embodiments 1-6, wherein the operations are performed in response to a request from the client.

Embodiment 8. The method as recited in any of embodiments 1-7, wherein the operations are performed as part of a Function-as-a-Service (FaaS) to which the client subscribes.

Embodiment 9. The method as recited in any of embodiments 1-8, wherein the compliance score is updated automatically in response to receipt of new/modified supplier responses.

Embodiment 10. The method as recited in any of embodiments 1-9, further comprising conveying, with client permission, client input to the supplier.

Embodiment 11. A system, comprising hardware and/or software, for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions may comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed herein, including a client, supplier, and automated ESG mapping platform, may take the form of, or include, or be implemented on, or hosted by, a physical computing device. As well, where any of the aforementioned elements comprise or consist of a virtual machine (VM), that VM may constitute a virtualization of any combination of the physical components disclosed herein.

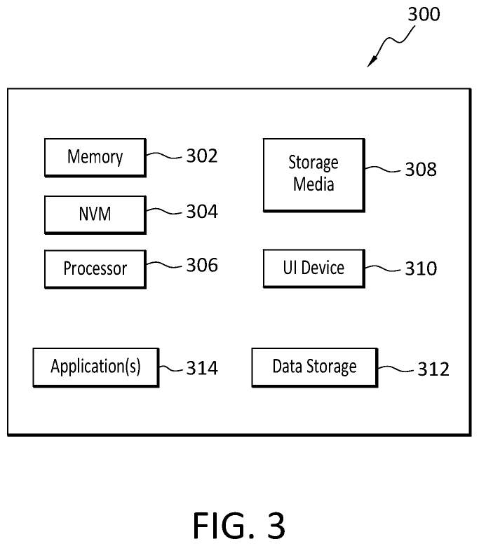

With reference briefly now to FIG. 3, any one or more of the entities disclosed, or implied, by FIGS. 1-2 and/or elsewhere herein, may take the form of, or include, or be implemented on, or hosted by, a computing device that may comprise hardware and/or software, one example of which is denoted at 300.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more processors 306 which may comprise hardware processors, non-transitory storage media 308, UI (user interface) device 310, and data storage 312. One or more of the memory components 302 of the computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
performing, by an automated ESG mapping platform, operations comprising:
determining, based on criteria, a sustainability query for a supplier, wherein the criteria include standards identified by a client, types of suppliers specified by the client, and a maturity level of the supplier;
prompting the supplier to respond to the sustainability query;
receiving supplier responses to the sustainability query;
creating a compliance score for the supplier based on the supplier responses to the sustainability query; and
providing the compliance score to the client.

2. The method as recited in claim 1, further comprising publishing the compliance score.

3. The method as recited in claim 1, wherein the maturity level is a function of any one or more of: a number of employees of the supplier; a geographic location of the supplier; an ESG historical trend of the supplier; or, a level of regulation in an industry of the supplier.

4. The method as recited in claim 1, wherein the maturity level is determined using a consortium approach that involves one or more clients in addition to the client.

5. The method as recited in claim 1, wherein the supplier compliance score comprises an ESG index that is specific to the client.

6. The method as recited in claim 1, wherein the supplier has only a single maturity level at any given time, regardless of how many clients the supplier has at that given time.

7. The method as recited in claim 1, wherein the operations are performed in response to a request from the client.

8. The method as recited in claim 1, wherein the operations are performed as part of a Function-as-a-Service (FaaS) to which the client subscribes.

9. The method as recited in claim 1, wherein the compliance score is updated automatically in response to receipt of new/modified supplier responses.

10. The method as recited in claim 1, further comprising conveying, with client permission, client input to the supplier.

11. A non-transitory storage medium having stored therein instructions that are executable by one or more hardware processors to perform operations comprising:
determining, based on criteria, a sustainability query for a supplier, wherein the criteria include standards identified by a client, types of suppliers specified by the client, and a maturity level of the supplier;
prompting the supplier to respond to the sustainability query;
receiving supplier responses to the sustainability query;
creating a compliance score for the supplier based on the supplier responses to the sustainability query; and
providing the compliance score to the client,
wherein the operations are performed by an automated ESG mapping platform.

12. The non-transitory storage medium as recited in claim 11, further comprising publishing the compliance score.

13. The non-transitory storage medium as recited in claim 11, wherein the maturity level is a function of any one or more of: a number of employees of the supplier; a geographic location of the supplier; an ESG historical trend of the supplier; or, a level of regulation in an industry of the supplier.

14. The non-transitory storage medium as recited in claim 11, wherein the maturity level is determined using a consortium approach that involves one or more clients in addition to the client.

15. The non-transitory storage medium as recited in claim 11, wherein the supplier compliance score comprises an ESG index that is specific to the client.

16. The non-transitory storage medium as recited in claim 11, wherein the supplier has only a single maturity level at any given time, regardless of how many clients the supplier has at that given time.

17. The non-transitory storage medium as recited in claim 11, wherein the operations are performed in response to a request from the client.

18. The non-transitory storage medium as recited in claim 11, wherein the operations are performed as part of a Function-as-a-Service (FaaS) to which the client subscribes.

19. The non-transitory storage medium as recited in claim 11, wherein the compliance score is updated automatically in response to receipt of new/modified supplier responses.

20. The non-transitory storage medium as recited in claim 11, further comprising conveying, with client permission, client input to the supplier.
